(19) United States
(12) Patent Application Publication
(10) Pub. No.: US 2013/0321664 A1
(43) Pub. Date: Dec. 5, 2013

(54) PHOTOGRAPHING APPARATUS, METHOD OF CONTROLLING THE SAME, AND COMPUTER-READABLE RECORDING MEDIUM

(71) Applicant: SAMSUNG ELECTRONICS CO., LTD., Suwon-si (KR)

(72) Inventor: Jae-hyo Jung, Seongnam-si (KR)

(73) Assignee: SAMSUNG ELECTRONICS CO., LTD., Suwon-si (KR)

(21) Appl. No.: 13/753,830

(22) Filed: Jan. 30, 2013

(30) Foreign Application Priority Data
May 30, 2012 (KR) 10-2012-0057474

(51) Int. Cl. H04N 5/235

(52) U.S. Cl. CPC H04N 5/2353
USPC 348/229.1

(57) ABSTRACT

A method of controlling a photographing apparatus is provided according to an embodiment. The method includes comparing brightness between a preview image and a captured image; and compensating shutter traveling properties based on a difference in the brightness between the preview image and the captured image.

### CROSS-REFERENCE TO RELATED PATENT APPLICATION

This application claims the priority benefit of Korean Patent Application No. 10-2012-0057474, filed on May 30, 2012, in the Korean Intellectual Property Office, the disclosure of which is incorporated herein in its entirety by reference.

### BACKGROUND

Various embodiments relate to photographing apparatuses, methods of controlling the same, and computer-readable recording media.

Shutters of photographing apparatuses can be categorized into lens shutters and focal plane shutters. Lens shutters are placed in proximity to lenses, while focal plane shutters are placed near focal planes. Focal plane shutters are left-right shutters, up-down shutters, etc., depending on the moving direction of first and second curtains. A focal plane shutter is placed right in front of an image sensor of a camera, and light passed through a lens may be passed though or blocked by the focal plane shutter by opening or closing first and second curtains of the focal plane shutter in front of the image sensor of the camera. However, there is a problem in that brightness of captured images may be changed because of changes to travel properties of a focal plane shutter due to a difference between features of different products or due to a durability problem of a photographing apparatus.

### SUMMARY

The various embodiments provide photographing apparatuses, methods of controlling the same, and non-transitory computer-readable recording media to address the foregoing problem of a change in brightness of captured images resulting from changes of travel properties of shutters due to a difference between features of different products or due to a durability problem of a photographing apparatus.

According to an embodiment, there is provided a method of controlling a photographing apparatus, the method comprising: comparing brightness between a preview image and a captured image; and compensating traveling properties of a shutter based on a difference in the brightness between the preview image and the captured image.

The compensating of the shutter traveling properties may comprise: compensating the shutter traveling properties to decrease exposure time, when the captured image is brighter than the preview image; and compensating the shutter traveling properties to increase the exposure time, when the captured image is darker than the preview image.

The compensating of the shutter traveling properties to decrease the exposure time may comprise at least one of steps of: delaying a travel starting time of a first curtain of the shutter; and moving up a travel starting time of a second curtain of the shutter. And the compensating of the shutter traveling properties to increase the exposure time may comprise at least one of steps of: moving up the travel starting time of the first curtain of the shutter; and delaying the travel starting time of the second curtain of the shutter.

The shutter may comprise an electronic first curtain and a mechanical second curtain, wherein the compensating of the shutter traveling properties to decrease the exposure time may comprise moving up a travel starting time of the second curtain of the shutter, and the compensating of the shutter traveling properties to increase the exposure time comprises delaying the travel starting time of the second curtain of the shutter.

The preview image may comprise a preview image right before the captured image is captured.

The preview image is obtained at a frame rate that corresponds to a shutter speed of the captured image.

The comparing of the brightness between the preview image and the captured image and the compensating of the shutter traveling properties may be performed every time the predetermined reference number of photographing operations is performed by the photographing apparatus.

According to another embodiment, there is provided a photographing apparatus comprising: a brightness comparator that compares the brightness between a preview image and a captured image; and a shutter compensation unit that compensates shutter traveling properties based on a difference in the brightness between the preview image and the captured image.

The shutter compensation unit may compensate the shutter traveling properties to decrease exposure time, when the captured image is brighter than the preview image, and compensate the shutter traveling properties to increase the exposure time, when the captured image is darker than the preview image.

The shutter compensation unit may compensate the shutter traveling properties to decrease the exposure time, by delaying a travel starting time of a first curtain of the shutter, or moving up the travel starting time of the second curtain of the shutter, and compensate the shutter traveling properties to increase the exposure time, by moving up the travel starting time of the first curtain of the shutter, or delaying a travel starting time of a second curtain of the shutter.

The photographing apparatus may further comprises an electronic first curtain and a mechanical second curtain, wherein the compensating of the shutter traveling properties to decrease the exposure time comprises moving up the travel starting time of the second curtain of the shutter, and wherein the compensating of the shutter traveling properties to increase the exposure time comprises delaying the travel starting time of the second curtain of the shutter.

The preview image may comprise a preview image right before the captured image is captured.

The preview image may be obtained at a frame rate that corresponds to a shutter speed of the captured image.

The brightness comparator and the shutter compensation unit may perform operations of compensating the shutter travel properties every time the predetermined reference number of photographing operations is performed.

According to another embodiment, there is provided a non-transitory computer-readable recording medium having computer program codes embodied thereon that are read and executed by a processor, for carrying out a method of controlling a photographing device, the method comprising: comparing brightness between a preview image and a captured image; and compensating traveling properties of a shutter based on a difference in the brightness between the preview image and the captured image.

The compensating of the shutter traveling properties may comprise: compensating the shutter traveling properties to decrease exposure time, when the captured image is brighter than the preview image; and compensating the shutter traveling properties to increase the exposure time, when the captured image is darker than the preview image.

The compensating of the shutter traveling properties to decrease the exposure time may comprise: delaying a travel starting time of a first curtain of the shutter; and moving up a travel starting time of a second curtain of the shutter. And the compensating of the shutter traveling properties to increase the exposure time may comprise: moving up the travel starting time of the first curtain of the shutter; and delaying the travel starting time of the second curtain of the shutter.

The shutter may comprise an electronic first curtain and a mechanical second curtain, wherein the compensating of the shutter traveling properties to decrease the exposure time comprises moving up a travel starting time of the second curtain of the shutter, and the compensating of the shutter traveling properties to increase the exposure time comprises delaying the travel starting time of the second curtain of the shutter.

The preview image may comprise a preview image right before the captured image is captured.

The comparing of the brightness between the preview image and the captured image and the compensating of the shutter traveling properties may be performed every time the predetermined reference number of photographing operations is performed.

### BRIEF DESCRIPTION OF THE DRAWINGS

The above and other features and advantages will become more apparent by describing in detail exemplary embodiments thereof with reference to the attached drawings in which:

FIG. 1 is an arrangement of a photographing apparatus, according to an embodiment;

FIG. 2 is a schematic arrangement of a photographing unit of the photographing apparatus of FIG. 1;

FIGS. 3 and 4 are diagrams for explaining operations of first and second curtains of FIG. 2;

FIG. 5 is a diagram representing traveling properties of the first and second curtains, according to an embodiment;

FIG. 6 is a diagram of an arrangement of a CPU/DSP, according to an embodiment;

FIG. 7 is a flowchart of a method of controlling the photographing apparatus, according to an embodiment; and

FIG. 8 is a flowchart of a method of controlling the photographing apparatus, according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

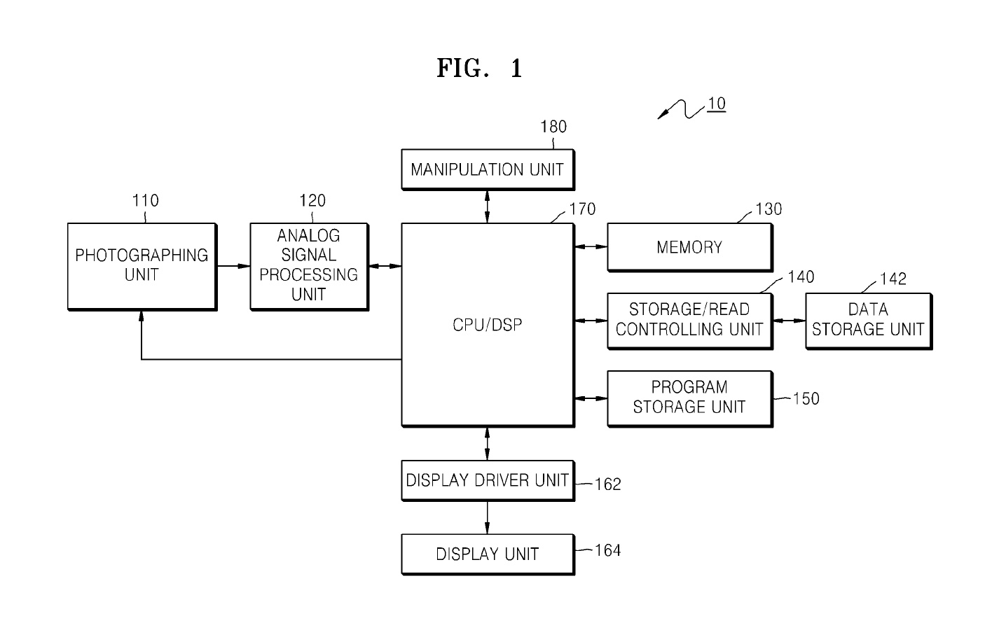

FIG. 1 is an arrangement of a photographing apparatus 10, according to an embodiment.

The apparatus 10 may include a photographing unit 110, an analog signal processing unit 120, a memory 130, a storage/read controlling unit 140, a data storage unit 142, a program storage unit 150, a display driver unit 162, a display unit 164, a CPU/DSP 170, and a manipulation unit 180.

All operations of the photographing apparatus 10 are controlled by the CPU/DSP 170. The CPU/DSP 170 provides the photographing unit 110 with control signals to operate them.

The photographing unit 110 includes a lens, a lens driver unit, an iris, an iris driver unit, a shutter, an imaging unit, and the photographing device controlling unit, all of which together forms images from electric signals from incident light.

The analog signal processing unit 120 performs noise reduction, gain adjustment, wave shaping, and analog-to-digital conversion on an analog signal provided by an imaging unit.

The signal processed by the analog signal processing unit 120 may be input to the CPU/DSP 170 either directly or via the memory 130. Here, the memory 130 serves as a main memory for the photographing apparatus 10 and temporarily stores necessary information during operation of the CPU/DSP 170. The program storage unit 150 stores programs, such as an operating system, application systems, etc., for running the photographing apparatus 10.

Furthermore, the photographing apparatus 10 includes a display unit 164 for displaying an operating status of the photographing apparatus 10, or image information captured by the photographing apparatus 10. The display unit 164 may provide visible- and/or audible-information for a user. To provide the visible information, the display unit 164 may be a liquid crystal display (LCD), an organic light-emitting display panel (OLED), etc. The display unit 164 may also be a touch screen that recognizes touch inputs.

The display driver unit 162 provides a driving signal for the display unit 164.

The CPU/DSP 170 processes input image signals, and controls each of components accordingly or according to an external input signal. The CPU/DSP 170 may perform image signal processing for image quality enhancement, such as noise reduction, gamma correction, color filter array interpolation, color matrix, color correction, color enhancement, etc., on input image data. Furthermore, the CPU/DSP 170 may create an image file by compressing image data obtained from the image signal processing for image quality enhancement, or reconstruct the image data from the image file. Compression formats of an image may be lossless compression formats or lossy compression formats. As an example of a proper compression format, in a case of a still image, there may be a Joint Photographic Experts Group (JPEG) or JPEG 2000 format. In a case of recording video images, a video file may be created by compressing a plurality of frames based on a Moving Picture Experts Group (MPEG) standard. The video file may also be created according to, for example, an Exchangeable Image File Format (EXIF) standard.

Image data output from the CPU/DSP 170 is input to the storage/read controlling unit 140 either directly or via the memory 130, and the CPU/DSP 170 then stores the image data in the data storage unit 142 either automatically or according to a signal from the user. The storage/read controlling unit 140 also reads data relating to any images from an image file stored in the data storage unit 142, and inputs the data to the display driver unit 162 for display either directly or through another path. The data storage unit 142 may be removable or permanently fixed in the photographing apparatus 10.

Furthermore, the CPU/DSP 170 may also perform obscure processing, color processing, blur processing, edge emphasis processing, image analysis processing, image recognition processing, image effect processing, etc. For the image recognition processing, face recognition, scene recognition, etc., may be performed. The CPU/DSP 170 may also perform display image signal processing for display on the display unit 164. For example, brightness level adjustment, color compensation, contrast adjustment, sharpness adjustment, screen division, character image creation and synthesis, etc., may be performed. The CPU/DSP 170 connected to an external monitor may perform predetermined image signal processing for display on the external monitor, and send the image data obtained from the predetermined image signal processing to the external monitor for display.

In addition, the CPU/DSP 170 may carry out a program stored in the program storage unit 130, have a separate module to create control signals for auto focusing, zoom changing, focus changing, automatic-exposure compensation, etc. and provide the control signals to the photographing unit 110, and generally control operations of all the components of the photographing apparatus 10, including shutters, speed light, etc.

The manipulation unit 180 enables the user to input control signals. The manipulation unit 180 may include various functionality buttons, such as a shutter-release button for exposing the photographing unit 110 to light for a predetermined period of time before taking pictures, a power button for inputting power-on and -off control signals, a zoom button for widening or narrowing an angle of an image, a mode selection button, a button for adjusting other setting values for photographing, etc. The manipulation unit 180 may be implemented as any type of input devices that enables the user to input control signals, such as a button, a keyboard, a touch pad, a touch screen, a remote control unit, etc.

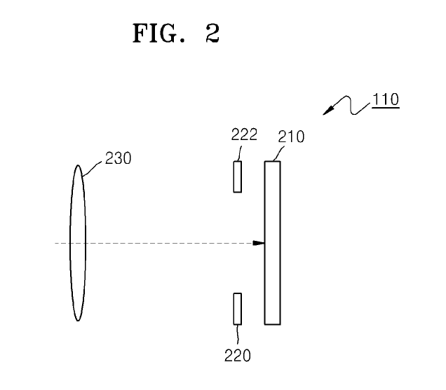

FIG. 2 is a schematic arrangement of the photographing unit 110 of the photographing apparatus 10 of FIG. 1.

The photographing unit 110 may include an imaging unit 210, shutters 220 and 222, and a lens 230.

The lens 230 may include groups of lenses or an individual lens. The lens 230 adjusts a channel of incident light. By adjusting a position of the lens 230, an image of an object may be formed on a light receiving surface of the imaging unit 210. The amount of light incident on the imaging unit 210 and a depth of the captured image may be adjusted by an iris (not shown) contained in the photographing unit 110.

An optical signal that has passed through the lens 230 and the iris reaches the light receiving surface of the imaging unit 210 and forms an image of an object on the light receiving surface. The imaging unit 210 may be a Charge Coupled Device (CCD), an image sensor, or a Complementary Metal Oxide Semiconductor Image Sensor (CIS) to convert the optical signal to an electrical signal. Sensitivity and other properties of the imaging unit 210 may be adjusted.

Exposure time of the imaging unit 210 is adjusted by the shutters 220 and 222. According to an embodiment, the shutters 220 and 222 correspond to a first curtain 220 and a second curtain 222, respectively, and they together constitute an up-down focal plane shutter. The exposure time is set by a user or by the CPU/DSP 170 automatically.

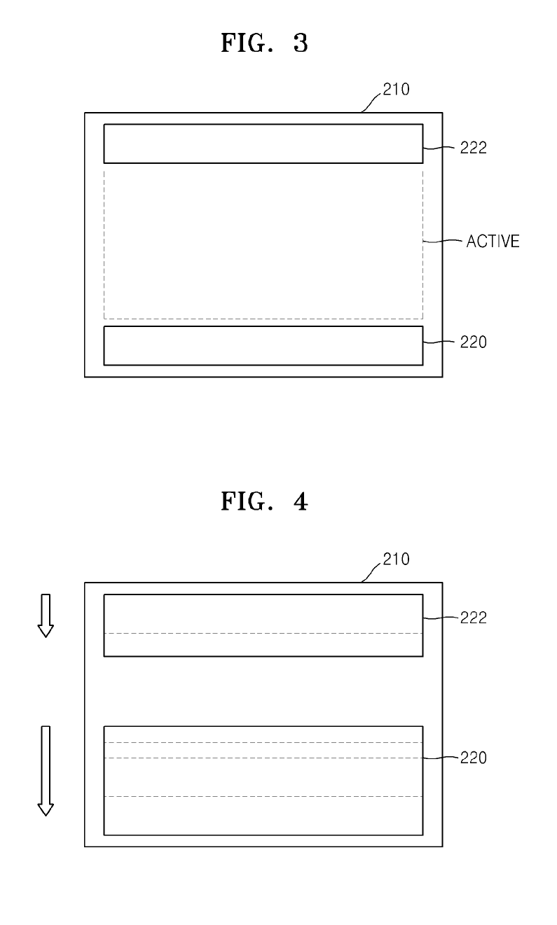

FIGS. 3 and 4 are diagrams for explaining operations of the first and second curtains 220 and 222 of FIG. 2.

In a preview mode, the shutters 220 and 222 open an active area of the imaging unit 210, in which optoelectronic conversion is made, to allow incident light to pass onto the imaging unit 210, as shown in FIG. 3. In this case, the first curtain 220 is placed around a bottom of the imaging unit 210 in a folded state, and the second curtain 222 is placed around a top of the imaging unit 210 in a folded state.

When a shutter-release signal is input, shutter travel begins, as shown in FIG. 4. First, the first curtain 220 shades the imaging unit 210 before exposure, and initiates the exposure by starting travel. The second curtain 222 starts traveling a predetermined time after the first curtain initiates the exposure, to shade the imaging unit 210. In this way, the focal plane shutter adjusts exposure of the imaging unit 210 while doing slit traveling (traveling while keeping a constant gap between the first and second curtains 220 and 222) in order to perform scanning with respect to the imaging unit 210. A difference in travel starting time between the first and second curtains 220 and 222 is set up to correspond to a presently set shutter speed.

According to an embodiment, in a preview mode, a frame rate of extracting preview images is set to correspond to the presently set shutter speed, so that exposure time of a frame in a preview image may be equal to exposure time of a captured image.

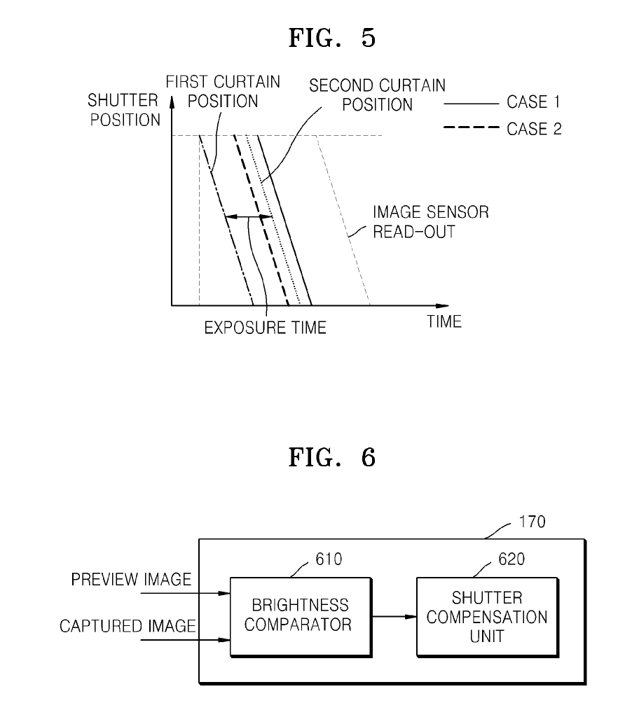

FIG. 5 is a diagram representing traveling properties of the first and second curtains 220 and 222, according to an embodiment.

As shown in FIG. 5, the first and second curtains 220 and 222 travel together with a time difference that corresponds to the exposure time. In this regard, due to a difference in shutter traveling properties between different products, the time difference between the first curtain 220 and the second curtain 222 may appear to be shorter (CASE 1) or longer (CASE 2) than the exposure time. Furthermore, aging of a product changes the shutter traveling properties, and thus the time difference between the first curtain 220 and the second curtain 222 may get shorter (CASE 1) or longer (CASE 2) than the exposure time. Embodiments provide compensation of the shutter traveling properties in a case in which the exposure time changes due to a change of the shutter traveling properties.

FIG. 6 is a block diagram of the CPU/DSP 170, according to an embodiment. The CPU/DSP 170 includes a brightness comparator 610 and a shutter compensation unit 620.

The brightness comparator 610 receives a captured image and a preview image formed on the imaging unit 210, and then compares brightness between the preview and captured images. Here, the preview image refers to a frame generated in the preview mode. The preview image refers to a preview image right before the captured image is captured. It may be a preview image right before the shutter-release signal is inputted, that is, right before the shutter-release button is completely pressed. As described above, as a frame rate of the preview image is set to correspond to a shutter speed of the captured image, brightness of the preview and captured images should be the same in a normal condition. If the brightness of the preview and captured images is not the same due to an error occurrence with respect to the shutter traveling properties, the embodiment provides compensation of the shutter traveling properties.

According to an embodiment, the brightness comparator 610 may calculate a brightness value of a predetermined area of each of the preview and captured images as brightness of each of the preview and captured images. According to an embodiment, the brightness comparator 610 may calculate the brightness from pixels at a center part of the preview or captured image. According to another embodiment, the brightness comparator 610 may calculate the brightness from a combination of pixels at the center part and a periphery of the preview or captured image.

The shutter compensation unit 620 compensates the shutter traveling properties when determining that the brightness of the preview and captured images is different. More specifically, the shutter compensation unit 620 adjusts the exposure time by compensating the travel starting time of each of the first and second curtains 220 and 222.

According to an embodiment, the shutter compensation unit 620 adjusts the shutter traveling properties to decrease the exposure time, when the captured image is brighter than the preview image. In order to decrease the exposure time, the shutter compensation unit 620 may delay the travel starting time of the first curtain 220, or move up the starting time of the second curtain 222.

According to an embodiment, the shutter compensation unit 620 compensates the shutter traveling properties to increase the exposure time, when the captured image is darker than the preview image. In order to increase the exposure time, the shutter compensation unit 620 may move up the travel starting time of the first curtain 220, or delay the starting time of the second curtain 222.

According to another embodiment, the first curtain 220 may be implemented in the form of an electronic first curtain. The electronic first curtain starts exposure from when application of a reset signal is finished, and stops the exposure by applying a reset signal to the imaging unit 210. In this case, compensation of the shutter traveling properties may be performed on the second curtain 222. More specifically, the shutter compensation unit 620 may move up the travel starting time of the second curtain 222, when the captured image is brighter than the preview image. Furthermore, the shutter compensation unit 620 may delay the travel starting time of the second curtain 222, when the captured image is darker than the preview image.

According to another embodiment, the operations of compensating the shutter traveling properties in the brightness comparator 610 and the shutter compensation unit 620 may be performed every time the predetermined reference number of capturing operations is performed by the photographing apparatus 10. For example, the compensation of the shutter traveling properties may be performed once every one hundred thousand photographing operations performed, and the compensated shutter traveling properties may then be applied for subsequent capturing. Such an arrangement provides an effect of preventing load of the photographing apparatus 10 from being excessively increased due to the compensation of the shutter traveling properties.

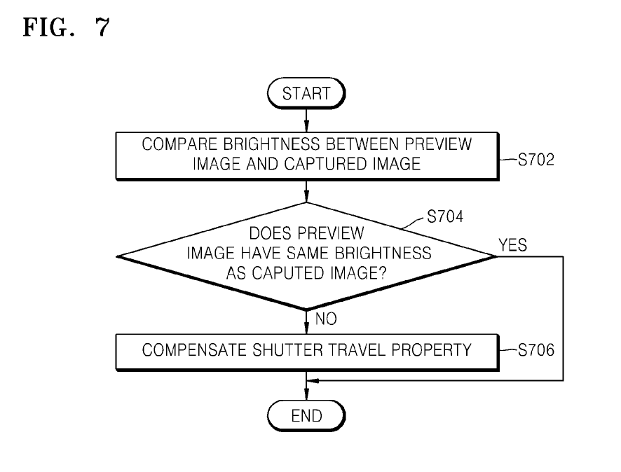

FIG. 7 is a flowchart of a method of controlling the photographing apparatus 10, according to an embodiment.

The method begins by comparing brightness between a preview image and a captured image in operation S702. According to an embodiment, brightness of each of the preview image and the captured image may be calculated to be an average brightness over the entire area of the image. According to another embodiment, the brightness of each of the preview image and the captured image may be calculated to be an average brightness of pixels in a center part of the image. According to another embodiment, the brightness of each of the preview image and the captured image may be calculated to be an average brightness of pixels in the center part and a periphery of the image.

The preview image may be an image right before the capture image is captured.

Next, the brightness of the preview image is compared with that of the captured image in operation S704. As the frame rate of the preview image has a value that corresponds to a shutter speed of the captured image, the preview and captured images having the same exposure time applied should have the same brightness value.

If the brightness of the preview image is not the same as that of the captured image, the shutter traveling properties are compensated for. More specifically, the compensation of the shutter traveling properties is performed by compensating the travel starting times of the first and second curtains 220 and 222 to adjust the exposure time.

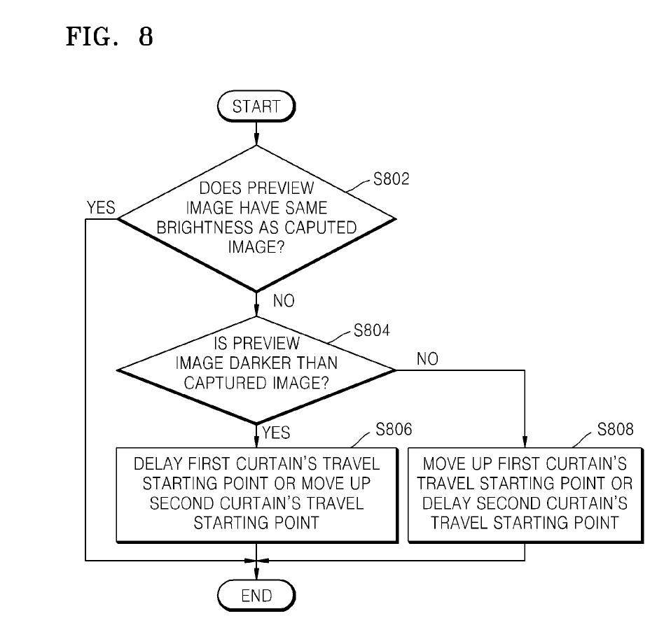

FIG. 8 is a flowchart of a method of controlling the photographing apparatus 10, according to another embodiment.

The method begins by comparing brightness between a preview image and a captured image in operation S802.

If the captured image is brighter than the preview image in operation S804, the shutter traveling properties are adjusted to decrease the exposure time in operation S806. More specifically, in order to decrease the exposure time, the travel starting time of the first curtain 220 may be delayed, or the travel starting time of the second curtain 222 may be moved up.

If the captured image is darker than the preview image in operation S804, the shutter traveling properties are adjusted to increase the exposure time in operation S808. More specifically, in order to increase the exposure time, the travel starting time of the first curtain 220 may be moved up, or the travel starting time of the second curtain 222 may be delayed.

According to another embodiment, the shutter's first curtain 220 may be implemented in the form of an electronic first curtain. In this case, the compensation of the shutter traveling properties may be performed on the second curtain 222. More specifically, if the captured image is brighter than the preview image, the travel starting time of the second curtain 222 may be moved up. Furthermore, if the captured image is darker than the preview image, the travel starting time of the second curtain 222 may be delayed.

According to another embodiment, the operations of compensating the shutter traveling properties may be performed every time the predetermined number of capturing operations is performed by the photographing apparatus 10. For example, the compensation of the shutter traveling properties may be performed every one hundred thousandth photographing, and the compensated shutter traveling properties may be applied for subsequent capturing. Such an arrangement gives an effect of preventing load of the photographing apparatus 10 from being excessively increased due to the compensation of the shutter traveling properties.

The device described herein may comprise a processor, a memory for storing program data and executing it, a permanent storage such as a disk drive, a communications port for communication with external devices, and user interface devices, such as a touch panel, keys, buttons, etc. When software modules or algorithms are involved, these software modules may be stored as program instructions or computer readable codes executable on the processor on a computer-readable medium. Examples of the computer readable recording medium include magnetic storage media (e.g., ROM, floppy disks, hard disks, etc.), and optical recording media (e.g., CD-ROMs, or DVDs). The computer readable recording medium can also be distributed over network coupled computer systems so that the computer readable code is stored and executed in a distributed fashion. This media can be read by a computer, stored in the memory, and executed by the processor.

All references, including publications, patent applications, and patents cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines, or other programming elements. Functional aspects may be implemented in algorithms that execute on one or more processors. Furthermore, the invention could employ any number of conventional techniques for electronics configuration, signal processing and/or control, data processing, and the like. The words “mechanism”, “element”, “means”, and “configuration” are used broadly and are not limited to mechanical or physical embodiments, but can include software routines in conjunction with processors, etc. The words can include software routines in conjunction with processors, etc.

The particular implementations shown and described herein are illustrative examples of the invention and are not intended to otherwise limit the scope of the invention in any way. For the sake of brevity, conventional electronics, control systems, software development, and other functional aspects of the systems may not be described in detail. Furthermore, the connecting lines or connectors shown in the various figures presented are intended to represent exemplary functional relationships and/or physical or logical couplings between the various elements. It should be noted that many alternative or additional functional relationships, physical connections, or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The invention is not limited to the described order of the steps. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A method of controlling a photographing apparatus, the method comprising:
comparing brightness between a preview image and a captured image; and
compensating traveling properties of a shutter based on a difference in the brightness between the preview image and the captured image.

2. The method of claim 1, wherein the compensating of the shutter traveling properties comprises:
compensating the shutter traveling properties to decrease exposure time, when the captured image is brighter than the preview image; and
compensating the shutter traveling properties to increase the exposure time, when the captured image is darker than the preview image.

3. The method of claim 2, wherein:
the compensating of the shutter traveling properties to decrease the exposure time comprises at least one of steps of:
delaying a travel starting time of a first curtain of the shutter; and
moving up a travel starting time of a second curtain of the shutter; and
the compensating of the shutter traveling properties to increase the exposure time comprises at least one of steps of:
moving up the travel starting time of the first curtain of the shutter; and
delaying the travel starting time of the second curtain of the shutter.

4. The method of claim 2, wherein the shutter comprises an electronic first curtain and a mechanical second curtain, and wherein:
the compensating of the shutter traveling properties to decrease the exposure time comprises moving up a travel starting time of the second curtain of the shutter, and
the compensating of the shutter traveling properties to increase the exposure time comprises delaying the travel starting time of the second curtain of the shutter.

5. The method of claim 1, wherein the preview image comprises a preview image right before the captured image is captured.

6. The method of claim 1, wherein the preview image is obtained at a frame rate that corresponds to a shutter speed of the captured image.

7. The method of claim 1, wherein the comparing of the brightness between the preview image and the captured image and the compensating of the shutter traveling properties are performed every time the predetermined reference number of photographing operations is performed by the photographing apparatus.

8. A photographing apparatus comprising:
a brightness comparator that compares the brightness between a preview image and a captured image; and
a shutter compensation unit that compensates shutter traveling properties based on a difference in the brightness between the preview image and the captured image.

9. The photographing apparatus of claim 8, wherein the shutter compensation unit:
compensates the shutter traveling properties to decrease exposure time, when the captured image is brighter than the preview image, and
compensates the shutter traveling properties to increase the exposure time, when the captured image is darker than the preview image.

10. The photographing apparatus of claim 9, wherein the shutter compensation unit:
compensates the shutter traveling properties to decrease the exposure time, by:
delaying a travel starting time of a first curtain of the shutter, or
moving up the travel starting time of the second curtain of the shutter, and
compensates the shutter traveling properties to increase the exposure time, by:
moving up the travel starting time of the first curtain of the shutter, or
delaying a travel starting time of a second curtain of the shutter.

11. The photographing apparatus of claim 9, further comprising an electronic first curtain and a mechanical second curtain, wherein:
the compensating of the shutter traveling properties to decrease the exposure time comprises moving up the travel starting time of the second curtain of the shutter, and
the compensating of the shutter traveling properties to increase the exposure time comprises delaying the travel starting time of the second curtain of the shutter.

12. The photographing apparatus of claim 8, wherein the preview image comprises a preview image right before the captured image is captured.

13. The photographing apparatus of claim 8, wherein the preview image is obtained at a frame rate that corresponds to a shutter speed of the captured image.

14. The photographing apparatus of claim 8, wherein the brightness comparator and the shutter compensation unit perform operations of compensating the shutter travel properties every time the predetermined reference number of photographing operations is performed.

15. A non-transitory computer-readable recording medium having computer program codes embodied thereon that are read and executed by a processor, for carrying out a method of controlling a photographing device, the method comprising:
comparing brightness between a preview image and a captured image; and
compensating traveling properties of a shutter based on a difference in the brightness between the preview image and the captured image.

16. The non-transitory computer-readable recording medium of claim 15, wherein the compensating of the shutter traveling properties comprises:
compensating the shutter traveling properties to decrease exposure time, when the captured image is brighter than the preview image; and
compensating the shutter traveling properties to increase the exposure time, when the captured image is darker than the preview image.

17. The non-transitory computer-readable recording medium of claim 16, wherein:
the compensating of the shutter traveling properties to decrease the exposure time comprises:
delaying a travel starting time of a first curtain of the shutter; and
moving up a travel starting time of a second curtain of the shutter; and
the compensating of the shutter traveling properties to increase the exposure time comprises:
moving up the travel starting time of the first curtain of the shutter; and
delaying the travel starting time of the second curtain of the shutter.

18. The non-transitory computer-readable recording medium of claim 16, wherein the shutter comprises an electronic first curtain and a mechanical second curtain, wherein:
the compensating of the shutter traveling properties to decrease the exposure time comprises moving up a travel starting time of the second curtain of the shutter, and
the compensating of the shutter traveling properties to increase the exposure time comprises delaying the travel starting time of the second curtain of the shutter.

19. The non-transitory computer-readable recording medium of claim 15, wherein the preview image comprises a preview image right before the captured image is captured.

20. The non-transitory computer-readable recording medium of claim 15, wherein the comparing of the brightness between the preview image and the captured image and the compensating of the shutter traveling properties are performed every time the predetermined reference number of photographing operations is performed.
